(19) United States
(12) Patent Application Publication
(10) Pub. No.: US 2005/0232448 A1
(43) Pub. Date: Oct. 20, 2005

(54) Audio signal switching mechanism

(76) Inventor: Ching-Hu Kung, Nw Edmonton (CA)

Correspondence Address: BIRCH STEWART KOLASCH & BIRCH, PO BOX 747, FALLS CHURCH, VA, 22040-0747, US

(21) Appl. No.: 10/811,950

(22) Filed: Mar. 30, 2004

(51) Int. Cl. H02B 1/00

(52) U.S. Cl. 381/123

(57) ABSTRACT

An audio signal switching mechanism includes at least an audio signal changing-over unit for selecting a signal input from an external signal source; a micro-processing unit electrically connected to the audio signal changing-over unit for processing an input signal selected by the latter; a double-tone multi-frequency receiving unit electrically connected to the micro-processing unit for detecting and decoding any signal input from an external signal source, and sending the decoded input signal to the micro-processing unit; and an audio signal multiplex processing unit electrically connected to the micro-processing unit and the audio signal changing-over unit for selecting or switching a signal passing through the audio signal changing-over unit via a microphone socket or an audio signal source socket, or input via an external signal source.

### FIELD OF THE INVENTION

The present invention relates to an audio signal switching mechanism that allows inputting and processing of a plurality of signal or sound sources, and outputs the input and processed signals to an external communication carrier for receiving the signals. When the signal sources are input simultaneously, a user may use the communication carrier to conveniently select a desired signal to be received without the need of using multiple apparatus, each of which has only one specific function, to receive or send the signal sources.

### BACKGROUND OF THE INVENTION

Various kinds of apparatus or equipment have been widely used in our daily life to receive and send different messages. However, with the conventional apparatus, a user is usually compelled to receive or send such messages without choice. Moreover, these apparatus are designed to receive or send specific signal source, and could not be integrated. In the case different signal sources need to be received or transmitted to obtain real-time information, such as using a computer to perform the function of ICQ, MSN, etc., using a stereo system to listen broadcasting news or music, or using a telephone to answer an incoming call or make a call, the user has to carry or be in the vicinity of all these apparatus. It is of course very inconvenient for the user to do so.

### SUMMARY OF THE INVENTION

A primary object of the present invention is to provide an audio signal switching mechanism to solve the above-mentioned problem with the conventional uni-functional apparatus for receiving and sending different signal sources.

The audio signal switching mechanism according to the present Invention allows inputting of a plurality of signal sources, and integrating and processing of the input signals, so that a user may conveniently select a desired signal to be received or sent without the need of using multiple uni-functional apparatus to receive or send the signals separately.

Another object of the present invention is to provide an audio signal switching mechanism that, upon inputting of any new signal source, is able to provide a prompt to draw the user's attention to select one signal source to be received, answered, or transmitted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram for an audio signal switching mechanism according to a preferred embodiment of the present invention; and

FIG. 2 is a circuit diagram for an audio signal switching mechanism according to a preferred embodiment of the present invention.

### DETAILED DESCRIPTION OF THE PREFERRED EMBODIMENTS

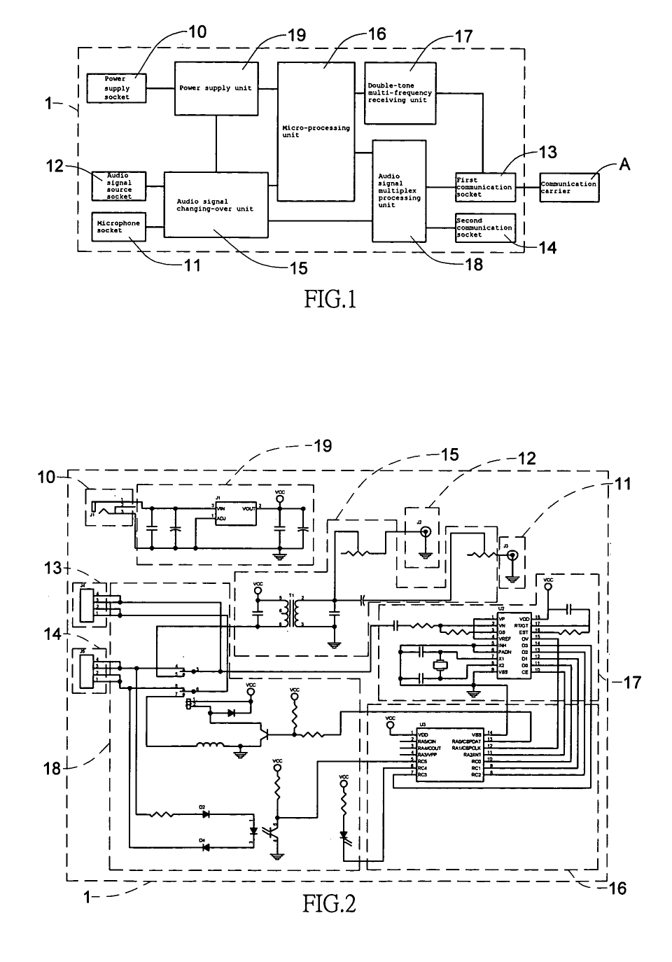

Please refer to FIGS. 1 and 2 that are block diagram and circuit diagram, respectively, for an audio signal switching mechanism 1 according to a preferred embodiment of the present invention. As shown, the audio signal switching mechanism 1 includes at least a power supply socket 10 for connecting to an external power source; a microphone socket 11 for connecting to an external microphone to input a signal collected by the microphone; an audio signal source socket 12 for connecting to an external signal-generating device or apparatus, including, for example, various audio-visual (AV) information apparatus, such as a stereo system, a television set, a computer, etc., that transmits music, news, voice information over networks (such as VoIP); a first communication socket 13 for connecting to an external communication carrier A, which may be, for example, a telephone (wired or wireless), a fax machine, etc., and inputting a signal from the external communication carrier A; a second communication socket 14 for connecting to an external signal line, such as a telephone line; an audio signal changing-over unit 15 electrically connected to the microphone socket 11 and the audio signal source socket 12 for selecting a signal input via the microphone socket 11 or the audio signal source socket 12; a micro-processing unit 16 electrically connected to the audio signal changing-over unit 15 for processing an input signal, such as, for example, converting an analog signal from or to a digital signal, transmitting a control signal, etc.; a double-tone multi-frequency receiving unit (DTMF) 17 having an end electrically connected to the first communication socket 13 and another end to the micro-processing unit 16 for detecting and decoding a signal input via the communication carrier A and sending the decoded signal to the micro-processing unit 16; an audio signal multiplex processing unit 18 electrically connected to the micro-processing unit 16, the audio signal changing-over unit 15, and the second communication socket 14 for selecting a signal (including a signal input via the microphone socket 11 or the audio signal source socket 12) passing through the audio signal changing-over unit 15, or a signal transmitted via the second communication socket 14, the audio signal multiplex processing unit 18 is also electrically connected to the first communication socket 13 for sending the above-mentioned signal that has been processed by the micro-processing unit 16 to the communication carrier A; and a power supply unit 19 having an end electrically connected to the power supply socket 10 to obtain necessary power supply, and anther end to the audio signal changing-over unit 15, the micro-processing unit 16, the double-tone multi-frequency receiving unit 17, and the audio signal multiplex processing unit 18 to provide stable power supply to these units.

The above-structured audio signal switching mechanism of the present invention may operate in the following steps:

In step 1, the audio signal changing-over unit 15 automatically switches according to any signal input via the microphone socket 11 or the audio signal source socket 12. In the event two signals are simultaneously input via the microphone socket 11 and the audio signal source socket 12, one of the two input signals will be selected first. For instance, when there is a signal inputting via the microphone socket 11, the audio signal source socket 12 is disabled and any signal is not able to input therefrom.

In step 2, the audio signal changing-over unit 15 is controlled by the micro-processing unit 16 to output the received signal to the audio signal multiplex processing unit 18, which, on receipt of the signal sent by the audio signal changing-over unit 15, is controlled by the micro-processing unit 16 to transmit the received signal to the communication carrier A via the first communication socket 13, so that a user may receive the input signal.

In step 3, when there is a signal input via the second communication socket 14, such as an incoming call via an external phone line, the input signal is passed through the audio signal multiplex processing unit 18 to be read by the micro-processing unit 16.

In step 4, the micro-processing unit 16 sends out a prompt to the communication carrier A via the audio signal multiplex processing unit 18, so that a user's attention is drawn to the input signal.

In step 5, the user may send out a selection signal via the communication carrier A to select whether to answer the signal input via the second communication socket 14.

In step 6, the double-tone multi-frequency receiving unit 17 detects and decodes the selection signal input via the communication carrier A.

In step 7, when a selection signal is transmitted by the double-tone multi-frequency receiving unit 17 to the micro-processing unit 16 and the latter reads the selection signal, the micro-processing unit 16 will, in step 8, control the audio signal multiplex processing unit 18 to switch the signal input via the microphone socket 11 or the audio signal source socket 12 to the second communication socket 14. However, when the user does not want to answer or receive the input signal via the second communication socket 14, it is also possible to keep the original receiving and transmitting manner.

The present invention has been described with a preferred embodiment thereof and it is understood that many changes and modifications in the described embodiment can be carried out without departing from the scope and the spirit of the invention. For example, the above-mentioned audio signal changing-over unit 15, the micro-processing unit 16, the double-tone multi-frequency receiving unit (DTMF) 17, the audio signal multiplex processing unit 18, and the power supply unit 19 may be integrated on one single chip, or more than one microphone socket 11, audio signal source socket 12, first communication socket 13, and second communication socket 14 may be provided for multiple signals to input at the same time and be selected or switched by the audio signal changing-over unit 15 and the audio signal multiplex processing unit 18. It is understood all equivalent effects produced due to such changes and modifications are included in the scope of the present invention that is intended to be limited only by the appended claims.

1. An audio signal switching mechanism, comprising at least an audio signal changing-over unit for selecting a signal input from an external signal source; a micro-processing unit electrically connected to said audio signal changing-over unit for processing an input signal selected by the latter; a double-tone multi-frequency receiving unit electrically connected to said micro-processing unit for detecting and decoding any signal input from an external signal source, and sending the decoded input signal to said micro-processing unit; and an audio signal multiplex processing unit electrically connected to said micro-processing unit and said audio signal changing-over unit for selecting or switching a signal passing through said audio signal changing-over unit or input via an external signal source.

2. The audio signal switching mechanism as claimed in claim 1, wherein said audio signal changing-over unit, said micro-processing unit, said double-tone multi-frequency receiving unit, said audio signal multiplex processing unit are electrically connected to a power supply unit.

3. The audio signal switching mechanism as claimed in claim 2, wherein said power supply unit has a power supply socket electrically connected thereto.

4. The audio signal switching mechanism as claimed in claim 1, wherein said audio signal changing-over unit has a microphone socket electrically connected thereto.

5. The audio signal switching mechanism as claimed in claim 1, wherein said audio signal changing-over unit has an audio signal source socket electrically connected thereto.

6. The audio signal switching mechanism as claimed in claim 1, wherein said double-tone multi-frequency receiving unit has a first communication socket electrically connected thereto.

7. The audio signal switching mechanism as claimed in claim 1, wherein said audio signal changing-over unit, said micro-processing unit, said double-tone multi-frequency receiving unit, and said audio signal multiplex processing unit are integrated on one single chip.

8. The audio signal switching mechanism as claimed in claim 2, wherein said audio signal changing-over unit, said micro-processing unit, said double-tone multi-frequency receiving unit, and said audio signal multiplex processing unit are integrated on one single chip.

9. The audio signal switching mechanism as claimed in claim 6, wherein said first communication socket has a communication carrier electrically connected thereto.

10. The audio signal switching mechanism as claimed in claim 9, wherein said communication carrier comprises a fax machine.

11. The audio signal switching mechanism as claimed in claim 9, wherein said communication carrier comprises a telephone.

12. The audio signal switching mechanism as claimed in claim 11, wherein said telephone comprises a wired telephone.

13. The audio signal switching mechanism as claimed in claim 11, wherein said telephone comprises a wireless telephone.

14. The audio signal switching mechanism as claimed in claim 1, wherein said audio signal multiplex processing unit has a second communication socket electrically connected thereto.

15. The audio signal switching mechanism as claimed in claim 14, wherein said second communication socket has a signal line electrically connected thereto.

16. The audio signal switching mechanism as claimed in claim 15, wherein said signal line comprises a telephone line.

17. The audio signal switching mechanism as claimed in claim 4, wherein said microphone socket has a microphone electrically connected thereto.

18. The audio signal switching mechanism as claimed in claim 5, wherein said audio signal source socket has a signal-generating apparatus electrically connected thereto.

19. The audio signal switching mechanism as claimed in claim 18, wherein said signal-generating apparatus comprises a computer.

20. The audio signal switching mechanism as claimed in claim 18, wherein said signal-generating apparatus comprises a stereo system.

21. The audio signal switching mechanism as claimed in claim 18, wherein said signal-generating apparatus comprises a television set.
